(19) United States
(12) Patent Application Publication
(10) Pub. No.: US 2025/0225358 A1
(43) Pub. Date: Jul. 10, 2025

(54) RADIO FREQUENCY IDENTIFICATION TAG

(71) Applicant: QUALCOMM Incorporated, San Diego, CA (US)

(72) Inventors: Ahmed ELSHAFIE, San Diego, CA (US); Zhikun WU, Beijing (CN); Yuchul KIM, San Diego, CA (US); Linhai HE, San Diego, CA (US); Huilin XU, Temecula, CA (US); Krishna Kiran MUKKAVILLI, San Diego, CA (US); Tingfang JI, San Diego, CA (US)

(21) Appl. No.: 18/850,754

(22) PCT Filed: Jun. 7, 2022
(86) PCT No.: PCT/CN2022/097305

§ 371 Date: Sep. 25, 2024

(51) Int. Cl. G06K 19/07; H04B 7/06; H04W 52/38

(52) U.S. Cl. CPC G06K 19/0715; H04B 7/0617; H04W 52/38

(57) ABSTRACT

Various aspects of the present disclosure generally relate to wireless communication. In some aspects, a radio frequency identification (RFID) tag may include a sensing component, an energy storage component, a power control command and beam control command processing unit, and at least one of a waveform generator, a power amplifier, or a low noise amplifier for providing a power signal to the RFID tag. The RFID tag may transmit capability information that indicates a waveform generation capability of the RFID tag or a power control capability of the RFID tag. The RFID may receive, from a network node, an indication to perform a power control operation or a beam adjustment operation based at least in part on the capability information. Numerous other aspects are described.

### FIELD OF THE DISCLOSURE

Aspects of the present disclosure generally relate to wireless communication and to techniques and apparatuses for a radio frequency identification tag.

### BACKGROUND

Wireless communication systems are widely deployed to provide various

telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a radio frequency identification (RFID) tag. The RFID tag may include a sensing component, an energy storage component, a power control command and beam control command processing unit, and at least one of a waveform generator, a power amplifier, or a low noise amplifier for providing a power signal to the RFID tag.

Some aspects described herein relate to a method of wireless communication performed by an RFID tag. The method may include transmitting capability information that indicates a waveform generation capability of the RFID tag or a power control capability of the RFID tag. The method may include receiving, from a network node, an indication to perform a power control operation or a beam adjustment operation based at least in part on the capability information.

Some aspects described herein relate to a method of wireless communication performed by a network node. The method may include receiving, from an RFID tag, capability information that indicates a waveform generation capability of the RFID tag or a power control capability of the RFID tag. The method may include transmitting, to the RFID tag, an indication to perform a power control operation or a beam adjustment operation based at least in part on the capability information.

Some aspects described herein relate to an apparatus for wireless communication performed by a an RFID tag. The RFID tag may include a memory and one or more processors, coupled to the memory. The one or more processors may be configured to transmit capability information that indicates a waveform generation capability of the RFID tag or a power control capability of the RFID tag. The one or more processors may be configured to receive, from a network node, an indication to perform a power control operation or a beam adjustment operation based at least in part on the capability information.

Some aspects described herein relate to an apparatus for wireless communication performed by a network node. The apparatus may include a memory and one or more processors, coupled to the memory. The one or more processors may be configured to receive, from an RFID tag, capability information that indicates a waveform generation capability of the RFID tag or a power control capability of the RFID tag. The one or more processors may be configured to transmit, to the RFID tag, an indication to perform a power control operation or a beam adjustment operation based at least in part on the capability information.

Some aspects described herein relate to a non-transitory computer-readable medium that stores a set of instructions for wireless communication by an RFID tag. The set of instructions, when executed by one or more processors of the RFID, may cause the RFID to transmit capability information that indicates a waveform generation capability of the RFID tag or a power control capability of the RFID tag. The set of instructions, when executed by one or more processors of the RFID, may cause the RFID to receive, from a network node, an indication to perform a power control operation or a beam adjustment operation based at least in part on the capability information.

Some aspects described herein relate to a non-transitory computer-readable medium that stores a set of instructions for wireless communication by a network node. The set of instructions, when executed by one or more processors of the network node, may cause the network node to receive, from an RFID tag, capability information that indicates a waveform generation capability of the RFID tag or a power control capability of the RFID tag. The set of instructions, when executed by one or more processors of the network node, may cause the network node to transmit, to the RFID tag, an indication to perform a power control operation or a beam adjustment operation based at least in part on the capability information.

Some aspects described herein relate to an apparatus for wireless communication. The apparatus may include means for transmitting capability information that indicates a waveform generation capability of the apparatus or a power control capability of the apparatus. The apparatus may include means for receiving, from a network node, an indication to perform a power control operation or a beam adjustment operation based at least in part on the capability information.

Some aspects described herein relate to an apparatus for wireless communication. The apparatus may include means for receiving, from an RFID tag, capability information that indicates a waveform generation capability of the RFID tag or a power control capability of the RFID tag. The apparatus may include means for transmitting, to the RFID tag, an indication to perform a power control operation or a beam adjustment operation based at least in part on the capability information.

Aspects generally include a method, apparatus, system, computer program product, non-transitory computer-readable medium, user equipment, base station, network entity, network node, wireless communication device, and/or processing system as substantially described herein with reference to and as illustrated by the drawings.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of physical channels and reference signals in a wireless network, in accordance with the present disclosure.

FIG. 5 is a diagram illustrating an example of using beams for communications between a network node and a UE, in accordance with the present disclosure.

FIG. 6 is a diagram illustrating an example of radio frequency identification (RFID) communication, in accordance with the present disclosure.

FIGS. 7A-7B are diagrams illustrating examples of RFID components, in accordance with the present disclosure.

FIG. 8 is a diagram illustrating an example of communication timing between an RFID reader and an RFID tag, in accordance with the present disclosure.

FIGS. 9A-9B are diagrams illustrating examples of RFID tag powering, in accordance with the present disclosure.

FIG. 10 is a diagram illustrating an example of an RFID tag, in accordance with the present disclosure.

FIG. 11 is a diagram illustrating an example associated with RFID tag operations and communications, in accordance with the present disclosure.

FIG. 12 is a diagram illustrating an example associated with a communication session between an RFID tag and a network node, in accordance with the present disclosure.

FIG. 13 is a diagram illustrating an example process associated with RFID tag operations and communications, in accordance with the present disclosure.

FIG. 14 is a diagram illustrating an example process associated with RFID tag operations and communications, in accordance with the present disclosure.

FIG. 15 is a diagram of an example apparatus for wireless communication, in accordance with the present disclosure.

FIG. 16 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

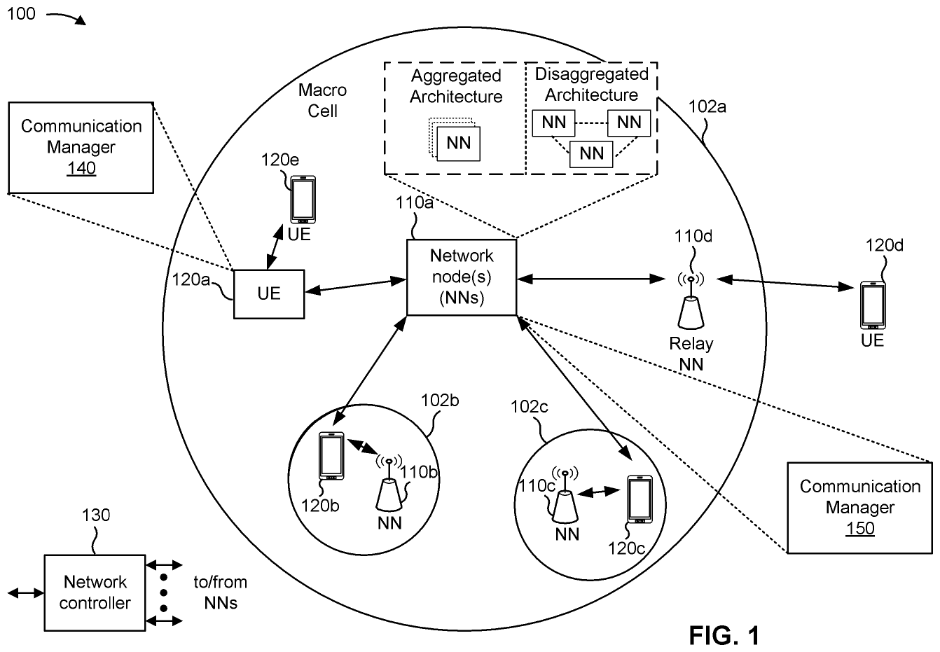

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the term “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the term “base station” or “network node” may refer to one device configured to perform one or more functions, such as those described herein in connection with the network node 110. In some aspects, the term “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the term “base station” or “network node” may refer to any one or more of those different devices. In some aspects, the term “base station” or “network node” may refer to one or more virtual base stations or one or more virtual base station functions. For example, in some aspects, two or more base station functions may be instantiated on a single device. In some aspects, the term “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHZ) and FR2 (24.25 GHZ-52.6GHz). It should be understood that although a portion of FRI is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHZ-71 GHz), FR4 (52.6 GHZ-114.25 GHZ), and FR5 (114.25 GHZ-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHZ, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 (e.g., a radio frequency identification (RFID) tag) may include a communication manager 140. As described in more detail elsewhere herein, the communication manager 140 may transmit capability information that indicates a waveform generation capability of the RFID tag or a power control capability of the RFID tag; and receive, from a network node, an indication to perform a power control operation or a beam adjustment operation based at least in part on the capability information. Additionally, or alternatively, the communication manager 140 may perform one or more other operations described herein.

In some aspects, the network node 110 may include a communication manager 150. As described in more detail elsewhere herein, the communication manager 150 may receive, from an RFID tag, capability information that indicates a waveform generation capability of the RFID tag or a power control capability of the RFID tag; and transmit, to the RFID tag, an indication to perform a power control operation or a beam adjustment operation based at least in part on the capability information. Additionally, or alternatively, the communication manager 150 may perform one or more other operations described herein.

As indicated above, FIG. 1 is provided as an example. Other examples may differ from what is described with regard to FIG. 1.

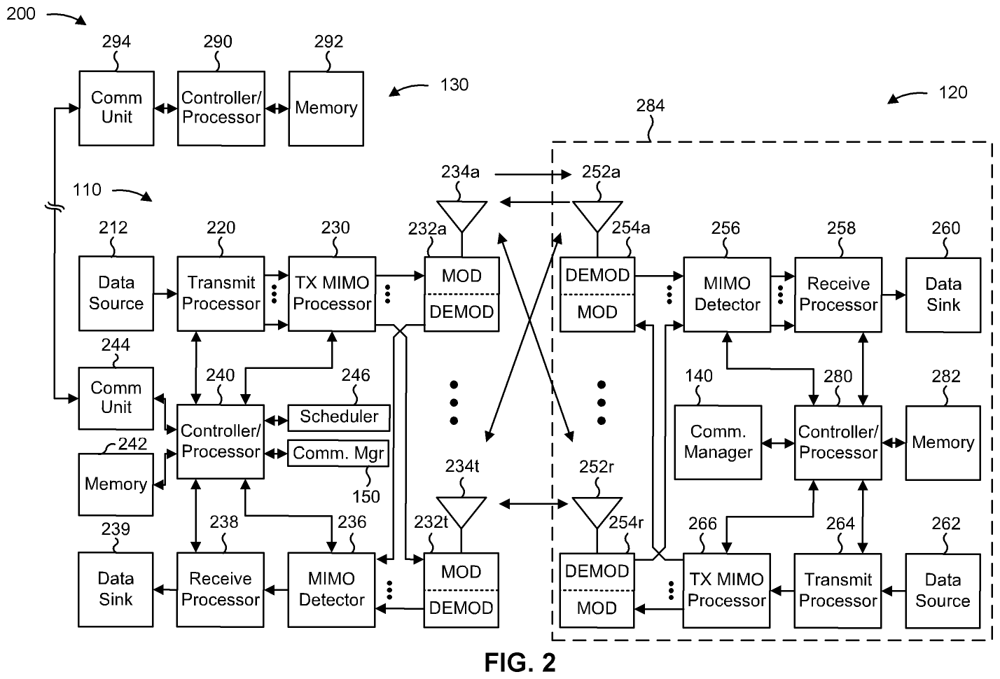

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

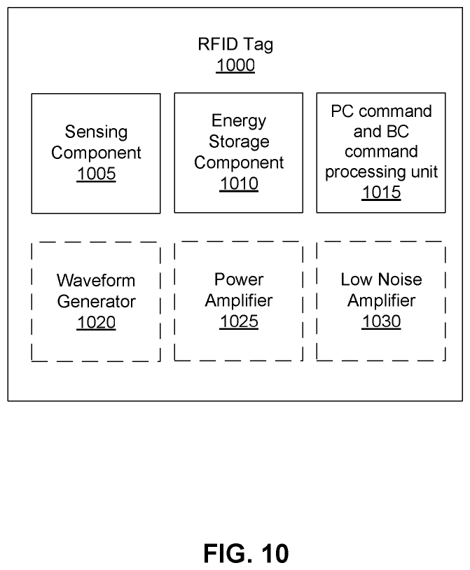

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 10-16).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 10-16).

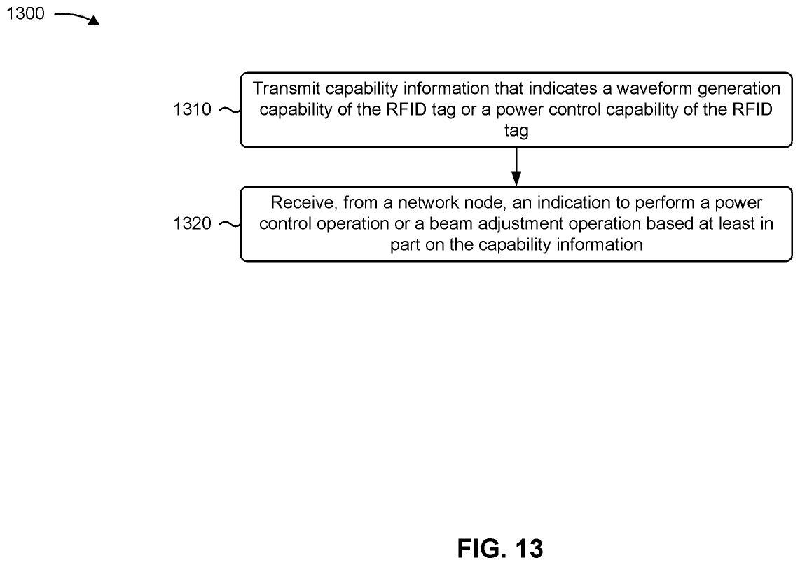

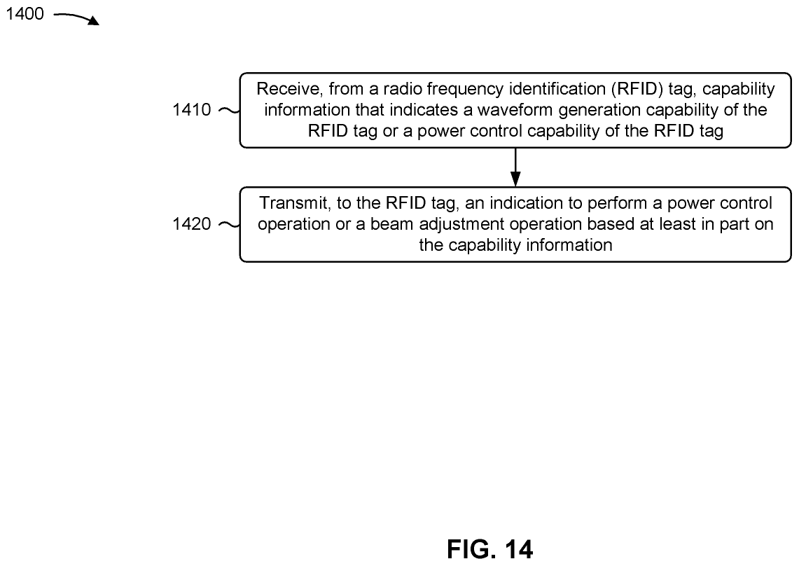

The controller/processor 240 of the network node 110, the controller/processor 280 of the UE 120, and/or any other component(s) of FIG. 2 may perform one or more techniques associated with an RFID tag, as described in more detail elsewhere herein. For example, the controller/processor 240 of the network node 110, the controller/processor 280 of the UE 120, and/or any other component(s) of FIG. 2 may perform or direct operations of, for example, process 1300 of FIG. 13, process 1400 of FIG. 14, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 1300 of FIG. 13, process 1400 of FIG. 14, and/or other processes as described herein. In some examples, executing instructions may include running the instructions, converting the instructions, compiling the instructions, and/or interpreting the instructions, among other examples.

In some aspects, the UE 120 (e.g., the RFID tag) includes means for transmitting capability information that indicates a waveform generation capability of the RFID tag or a power control capability of the RFID tag; and/or means for receiving, from a network node, an indication to perform a power control operation or a beam adjustment operation based at least in part on the capability information. In some aspects, the means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for receiving, from an RFID tag, capability information that indicates a waveform generation capability of the RFID tag or a power control capability of the RFID tag; and/or means for transmitting, to the RFID tag, an indication to perform a power control operation or a beam adjustment operation based at least in part on the capability information. In some aspects, the means for the network node 110 to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246. In some aspects, the means for the network node 110 to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

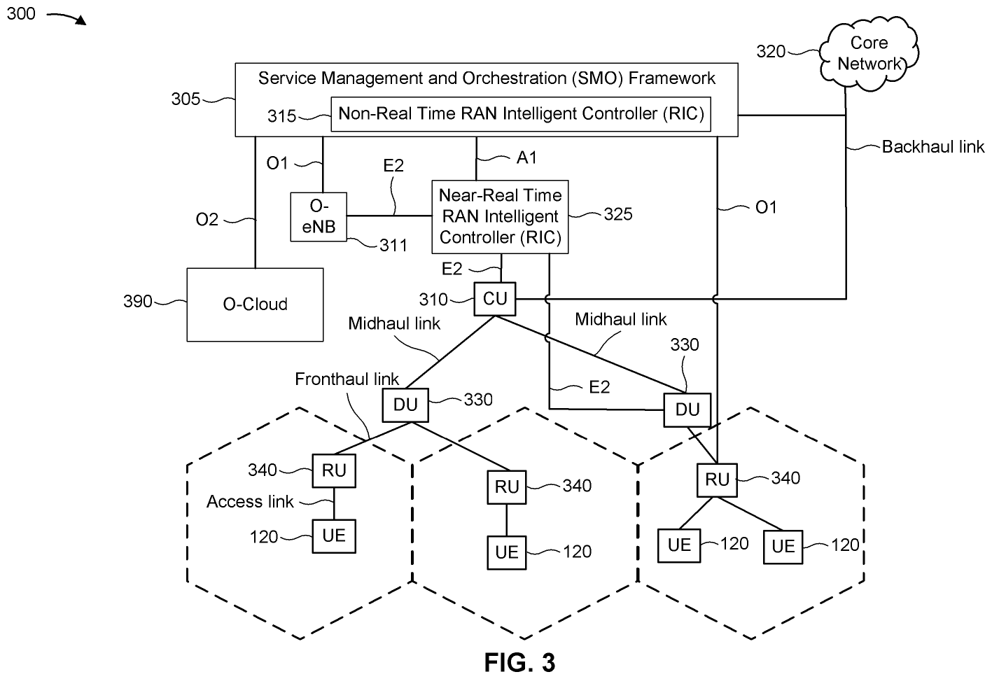

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a MAC layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an Al interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the non-RT RIC 315 or the Near-RT RIC 325 may be configured to tune RAN behavior or performance. For example, the non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

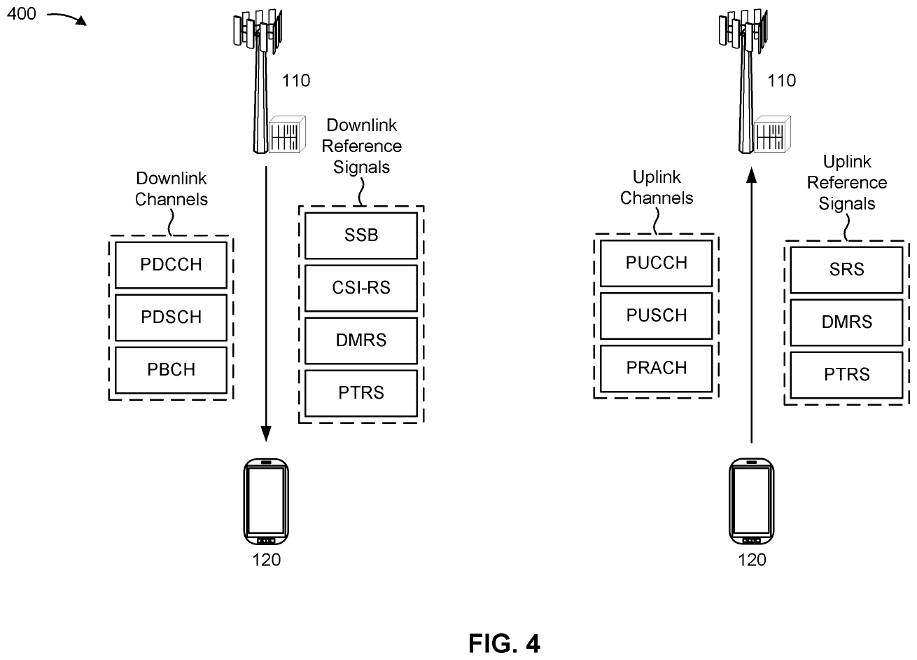

FIG. 4 is a diagram illustrating an example 400 of physical channels and reference signals in a wireless network, in accordance with the present disclosure. As shown in FIG. 4, downlink channels and downlink reference signals may carry information from a network node 110 to a UE 120, and uplink channels and uplink reference signals may carry information from a UE 120 to a network node 110.

As shown, a downlink channel may include a physical downlink control channel (PDCCH) that carries downlink control information (DCI), a physical downlink shared channel (PDSCH) that carries downlink data, or a physical broadcast channel (PBCH) that carries system information, among other examples. In some aspects, PDSCH communications may be scheduled by PDCCH communications. As further shown, an uplink channel may include a physical uplink control channel (PUCCH) that carries uplink control information (UCI), a physical uplink shared channel (PUSCH) that carries uplink data, or a physical random access channel (PRACH) used for initial network access, among other examples. In some aspects, the UE 120 may transmit acknowledgement (ACK) or negative acknowledgement (NACK) feedback (e.g., ACK/NACK feedback or ACK/NACK information) in UCI on the PUCCH and/or the PUSCH.

As further shown, a downlink reference signal may include a synchronization signal block (SSB), a channel state information (CSI) reference signal (CSI-RS), a demodulation reference signal (DMRS), a positioning reference signal (PRS), or a phase tracking reference signal (PTRS), among other examples. As also shown, an uplink reference signal may include a sounding reference signal (SRS), a DMRS, or a PTRS, among other examples.

An SSB may carry information used for initial network acquisition and synchronization, such as a primary synchronization signal (PSS), a secondary synchronization signal (SSS), a PBCH, and a PBCH DMRS. An SSB is sometimes referred to as a synchronization signal/PBCH (SS/PBCH) block. In some aspects, the network node 110 may transmit multiple SSBs on multiple corresponding beams, and the SSBs may be used for beam selection.

A CSI-RS may carry information used for downlink channel estimation (e.g., downlink CSI acquisition), which may be used for scheduling, link adaptation, or beam management, among other examples. The network node 110 may configure a set of CSI-RSs for the UE 120, and the UE 120 may measure the configured set of CSI-RSs. Based at least in part on the measurements, the UE 120 may perform channel estimation and may report channel estimation parameters to the network node 110 (e.g., in a CSI report), such as a channel quality indicator (CQI), a precoding matrix indicator (PMI), a CSI-RS resource indicator (CRI), a layer indicator (LI), a rank indicator (RI), or a reference signal received power (RSRP), among other examples. The network node 110 may use the CSI report to select transmission parameters for downlink communications to the UE 120, such as a number of transmission layers (e.g., a rank), a precoding matrix (e.g., a precoder), a modulation and coding scheme (MCS), or a refined downlink beam (e.g., using a beam refinement procedure or a beam management procedure), among other examples.

A DMRS may carry information used to estimate a radio channel for demodulation of an associated physical channel (e.g., PDCCH, PDSCH, PBCH, PUCCH, or PUSCH). The design and mapping of a DMRS may be specific to a physical channel for which the DMRS is used for estimation. DMRSs are UE-specific, can be beamformed, can be confined in a scheduled resource (e.g., rather than transmitted on a wideband), and can be transmitted only when necessary. As shown, DMRSs are used for both downlink communications and uplink communications.

A PTRS may carry information used to compensate for oscillator phase noise. Typically, the phase noise increases as the oscillator carrier frequency increases. Thus, PTRS can be utilized at high carrier frequencies, such as millimeter wave frequencies, to mitigate phase noise. The PTRS may be used to track the phase of the local oscillator and to enable suppression of phase noise and common phase error (CPE). As shown, PTRSs are used for both downlink communications (e.g., on the PDSCH) and uplink communications (e.g., on the PUSCH).

A PRS may carry information used to enable timing or ranging measurements of the UE 120 based on signals transmitted by the network node 110 to improve observed time difference of arrival (OTDOA) positioning performance. For example, a PRS may be a pseudo-random Quadrature Phase Shift Keying (QPSK) sequence mapped in diagonal patterns with shifts in frequency and time to avoid collision with cell-specific reference signals and control channels (e.g., a PDCCH). In general, a PRS may be designed to improve detectability by the UE 120, which may need to detect downlink signals from multiple neighboring network nodes in order to perform OTDOA-based positioning. Accordingly, the UE 120 may receive a PRS from multiple cells (e.g., a reference cell and one or more neighbor cells), and may report a reference signal time difference (RSTD) based on OTDOA measurements associated with the PRSs received from the multiple cells. In some aspects, the network node 110 may then calculate a position of the UE 120 based on the RSTD measurements reported by the UE 120.

An SRS may carry information used for uplink channel estimation, which may be used for scheduling, link adaptation, precoder selection, or beam management, among other examples. The network node 110 may configure one or more SRS resource sets for the UE 120, and the UE 120 may transmit SRSs on the configured SRS resource sets. An SRS resource set may have a configured usage, such as uplink CSI acquisition, downlink CSI acquisition for reciprocity-based operations, uplink beam management, among other examples. The network node 110 may measure the SRSs, may perform channel estimation based at least in part on the measurements, and may use the SRS measurements to configure communications with the UE 120.

As indicated above, FIG. 4 is provided as an example. Other examples may differ from what is described with regard to FIG. 4.

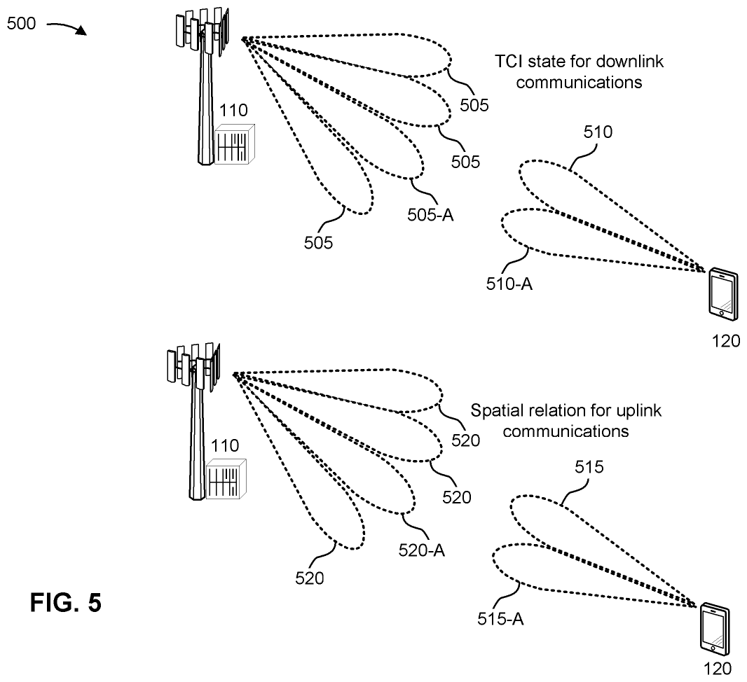

FIG. 5 is a diagram illustrating an example 500 of using beams for communications between a network node and a UE, in accordance with the present disclosure. As shown in FIG. 5, a network node 110 and a UE 120 may communicate with one another.

The network node 110 may transmit to UEs 120 located within a coverage area of the network node 110. The network node 110 and the UE 120 may be configured for beamformed communications, where the network node 110 may transmit in the direction of the UE 120 using a directional BS transmit beam, and the UE 120 may receive the transmission using a directional UE receive beam. Each BS transmit beam may have an associated beam ID, beam direction, or beam symbols, among other examples. The network node 110 may transmit downlink communications via one or more BS transmit beams 505.

The UE 120 may attempt to receive downlink transmissions via one or more UE receive beams 510, which may be configured using different beamforming parameters at receive circuitry of the UE 120. The UE 120 may identify a particular BS transmit beam 505, shown as BS transmit beam 505-A, and a particular UE receive beam 510, shown as UE receive beam 510-A, that provide relatively favorable performance (for example, that have a best channel quality of the different measured combinations of BS transmit beams 505 and UE receive beams 510). In some examples, the UE 120 may transmit an indication of which BS transmit beam 505 is identified by the UE 120 as a preferred BS transmit beam, which the network node 110 may select for transmissions to the UE 120. The UE 120 may thus attain and maintain a beam pair link (BPL) with the network node 110 for downlink communications (for example, a combination of the BS transmit beam 505-A and the UE receive beam 510-A), which may be further refined and maintained in accordance with one or more established beam refinement procedures.

A downlink beam, such as a BS transmit beam 505 or a UE receive beam 510, may be associated with a transmission configuration indication (TCI) state. A TCI state may indicate a directionality or a characteristic of the downlink beam, such as one or more quasi-co-location (QCL) properties of the downlink beam. A QCL property may include, for example, a Doppler shift, a Doppler spread, an average delay, a delay spread, or spatial receive parameters, among other examples. In some examples, each BS transmit beam 505 may be associated with a synchronization signal block (SSB), and the UE 120 may indicate a preferred BS transmit beam 505 by transmitting uplink transmissions in resources of the SSB that are associated with the preferred BS transmit beam 505. A particular SSB may have an associated TCI state (for example, for an antenna port or for beamforming). The network node 110 may, in some examples, indicate a downlink BS transmit beam 505 based at least in part on antenna port QCL properties that may be indicated by the TCI state. A TCI state may be associated with one downlink reference signal set (for example, an SSB and an aperiodic, periodic, or semi-persistent CSI-RS) for different QCL types (for example, QCL types for different combinations of Doppler shift, Doppler spread, average delay, delay spread, or spatial receive parameters, among other examples). In cases where the QCL type indicates spatial receive parameters, the QCL type may correspond to analog receive beamforming parameters of a UE receive beam 510 at the UE 120. Thus, the UE 120 may select a corresponding UE receive beam 510 from a set of BPLs based at least in part on the network node 110 indicating a BS transmit beam 505 via a TCI indication.

The network node 110 may maintain a set of activated TCI states for downlink shared channel transmissions and a set of activated TCI states for downlink control channel transmissions. The set of activated TCI states for downlink shared channel transmissions may correspond to beams that the network node 110 uses for downlink transmission on a physical downlink shared channel (PDSCH). The set of activated TCI states for downlink control channel communications may correspond to beams that the network node 110 may use for downlink transmission on a physical downlink control channel (PDCCH) or in a control resource set (CORESET). The UE 120 may also maintain a set of activated TCI states for receiving the downlink shared channel transmissions and the CORESET transmissions. If a TCI state is activated for the UE 120, then the UE 120 may have one or more antenna configurations based at least in part on the TCI state, and the UE 120 may not need to reconfigure antennas or antenna weighting configurations. In some examples, the set of activated TCI states (for example, activated PDSCH TCI states and activated CORESET TCI states) for the UE 120 may be configured by a configuration message, such as an RRC message.

Similarly, for uplink communications, the UE 120 may transmit in the direction of the network node 110 using a directional UE transmit beam, and the network node 110 may receive the transmission using a directional BS receive beam. Each UE transmit beam may have an associated beam ID, beam direction, or beam symbols, among other examples. The UE 120 may transmit uplink communications via one or more UE transmit beams 515.

The network node 110 may receive uplink transmissions via one or more BS receive beams 520. The network node 110 may identify a particular UE transmit beam 515, shown as UE transmit beam 515-A, and a particular BS receive beam 520, shown as BS receive beam 520-A, that provide relatively favorable performance (for example, that have a best channel quality of the different measured combinations of UE transmit beams 515 and BS receive beams 520). In some examples, the network node 110 may transmit an indication of which UE transmit beam 515 is identified by the network node 110 as a preferred UE transmit beam, which the network node 110 may select for transmissions from the UE 120. The UE 120 and the network node 110 may thus attain and maintain a BPL for uplink communications (for example, a combination of the UE transmit beam 515-A and the BS receive beam 520-A), which may be further refined and maintained in accordance with one or more established beam refinement procedures. An uplink beam, such as a UE transmit beam 515 or a BS receive beam 520, may be associated with a spatial relation. A spatial relation may indicate a directionality or a characteristic of the uplink beam, similar to one or more QCL properties, as described above.

As indicated above, FIG. 5 is provided as an example. Other examples may differ from what is described with respect to FIG. 5.

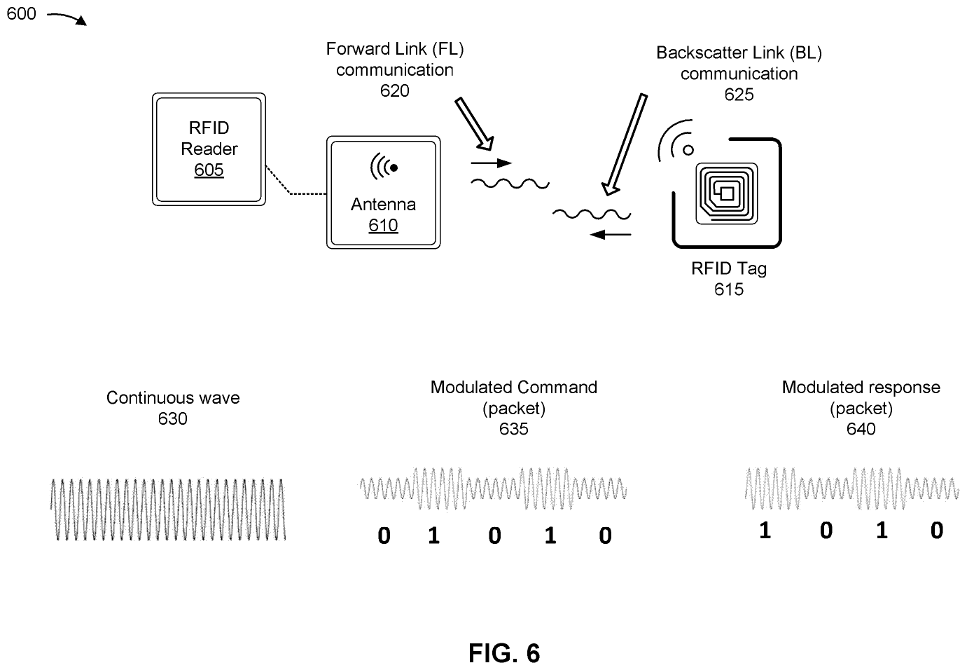

FIG. 6 is a diagram illustrating an example 600 of RFID communication, in accordance with the present disclosure. An RFID reader 605 may be associated with an antenna 610. The antenna 610 may be configured to transmit, and an RFID tag 615 may be configured to receive, a forward link communication 620. In some cases, the forward link communication 620 may include a continuous wave signal, such as the continuous wave 630. The continuous wave 630 may be a sine wave. Additionally, or alternatively, the forward link communication 620 may include a modulated signal, such as the modulated command 635. The RFID tag 615 may be configured to generate a modulated response 640 based at least in part on the continuous wave 630 and/or the modulated command 635. The RFID tag 615 may transmit, and the RFID reader 605 and/or the antenna 610 may receive, a backscatter link communication 625 that includes the modulated response 640. In one example, the modulated response 640 may include information about the RFID tag, such as a location of the RFID tag or one or more properties of an object associated with the RFID tag.

As indicated above, FIG. 6 is provided as an example. Other examples may differ from what is described with respect to FIG. 6.

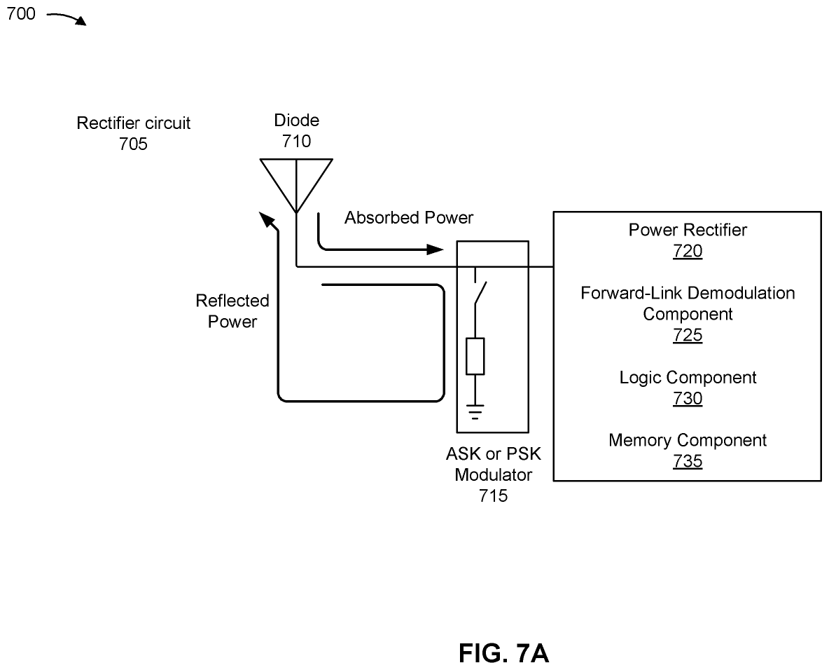

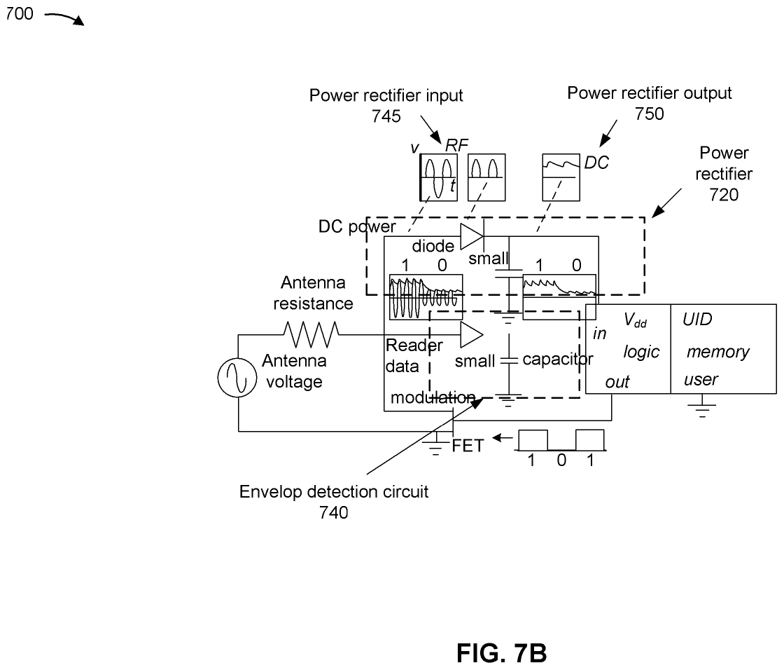

FIGS. 7A-7B are diagrams illustrating an example 700 of RFID components, in accordance with the present disclosure. As shown in FIG. 7A, a rectifier circuit 705 may include a diode 710. Power that is absorbed into the diode 710 may be sent to an amplitude shift keying (ASK) or phase shift keying (PSK) modulator 715. In some cases, the rectifier circuit 705 may include one or more of a power rectifier 720, a forward link demodulation component 725, a logic component 730, and/or a memory component 725. The power rectifier 720 may be configured, for example, to convert an alternating current (AC) signal to a direct current (DC) signal. The forward-link demodulation component 725 may be configured to demodulate a signal, such as by extracting a signal from a carrier wave. The logic component 730 may be configured to perform one or more programmable operations. The memory component 735 may be configured to store information associated with the rectifier circuit 705.

As shown in FIG. 7B, the RFID tag (e.g., a passive RFID tag) may include the power rectifier 720 and an envelope detection circuit 740. As described above, the power rectifier 720 may receive an AC signal as a power rectifier input 745 and may output a DC signal as a power rectifier output 750. During a backscatter or reading phase, the DC signal may be reflected and may be modulated with a sequence of bits. Using the envelope detection circuit 740, the passive RFID tag may compare the DC signal to an average signal. The passive RFID tag may generate an output having a first state (e.g., “0”) based at least in part on the DC signal having a value that is less than a value of the average signal. Alternatively, the passive RFID tag may generate an output having a second state (e.g., “1”) based at least in part on the DC signal having a value that is greater than, or greater than or equal to, the value of the average signal.

As indicated above, FIGS. 7A-7B are provided as examples. Other examples may differ from what is described with respect to FIGS. 7A-7B.

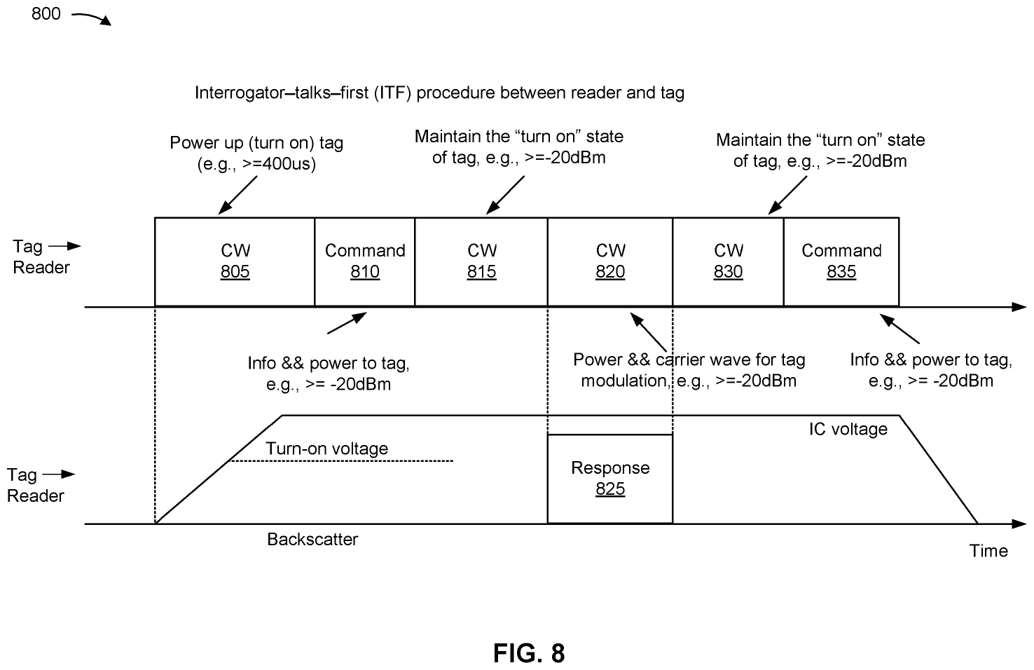

FIG. 8 is a diagram illustrating an example 800 of communication timing between an RFID reader and an RFID tag, in accordance with the present disclosure. In some cases, the communication may be an interrogator-talks-first (ITF) (e.g., an RFID reader-talks-first) procedure between the RFID reader and the RFID tag. In a first slot 805, the RFID reader 605 may transmit a continuous wave (CW) signal. The CW signal may be used to power up the RFID tag 615. For example, the RFID tag 615 may have a power level that is less than a turn-on voltage for the RFID tag 615 prior to receiving the CW signal. However, as the RFID tag 615 receives the CW signal, the power level of the RFID tag 615 may increase. For example, the power level of the RFID tag 615 may increase until the power level is greater than, or greater than or equal to, the turn-on voltage. At this point, the RFID tag 615 may be considered to be powered-up (e.g., turned on). In some cases, the time period for the RFID tag 615 to be powered-up may be at least 400 microseconds (us). In some cases, the RFID tag 615 may be considered to be powered-up when the power level of the RFID tag 615 is at least 20 decibel milliwatts (dBm). In a second slot 810, a command may be received by the RFID tag 615. In a third slot 815, a fourth slot 820, and a fifth slot 830, the RFID tag 615 may need to maintain the powered-up state of the RFID tag 615, such as by maintaining the power level of at least 20 dBm. For example, the RFID tag 615 may maintain the powered-up state of the RFID tag 615 based at least in part on receiving the CW signal from the RFID reader 605. As shown by reference number 825, the RFID tag 615 may transmit a response (e.g., a modulated command or a backscatter signal) during the time period corresponding to the fourth slot 820 and while the RFID tag 615 is in the powered-up state. In a sixth slot 835, the RFID reader 605 may transmit, and the RFID tag 615 may receive, a command, such as a command to power down the RFID tag 615. The RFID tag 615 may enter a powered off state based at least in part on receiving the command.

As indicated above, FIG. 8 is provided as an example. Other examples may differ from what is described with respect to FIG. 8.

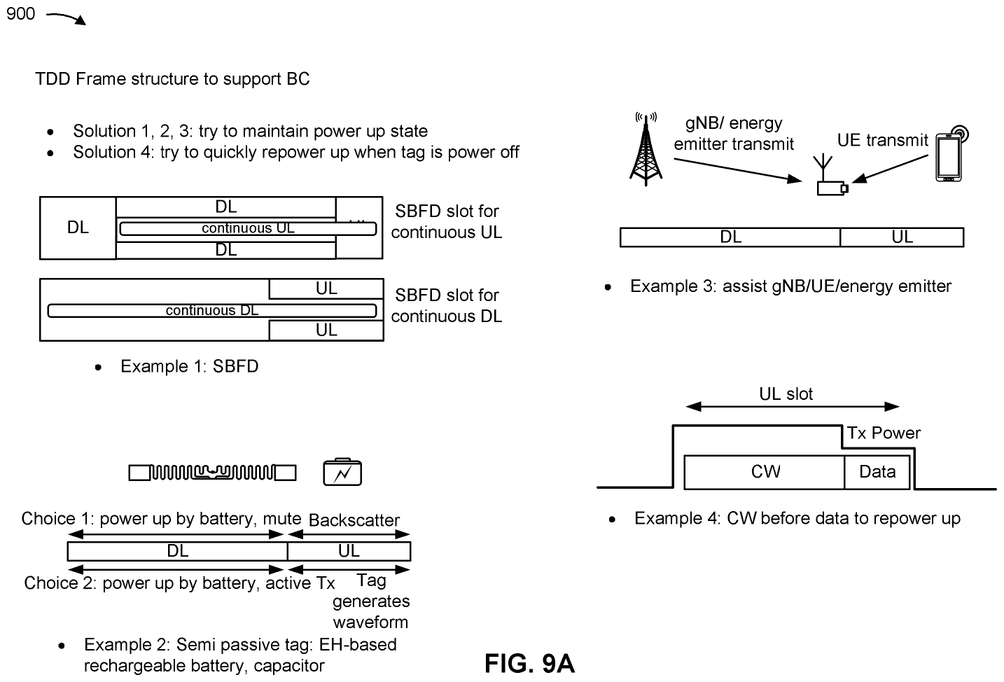

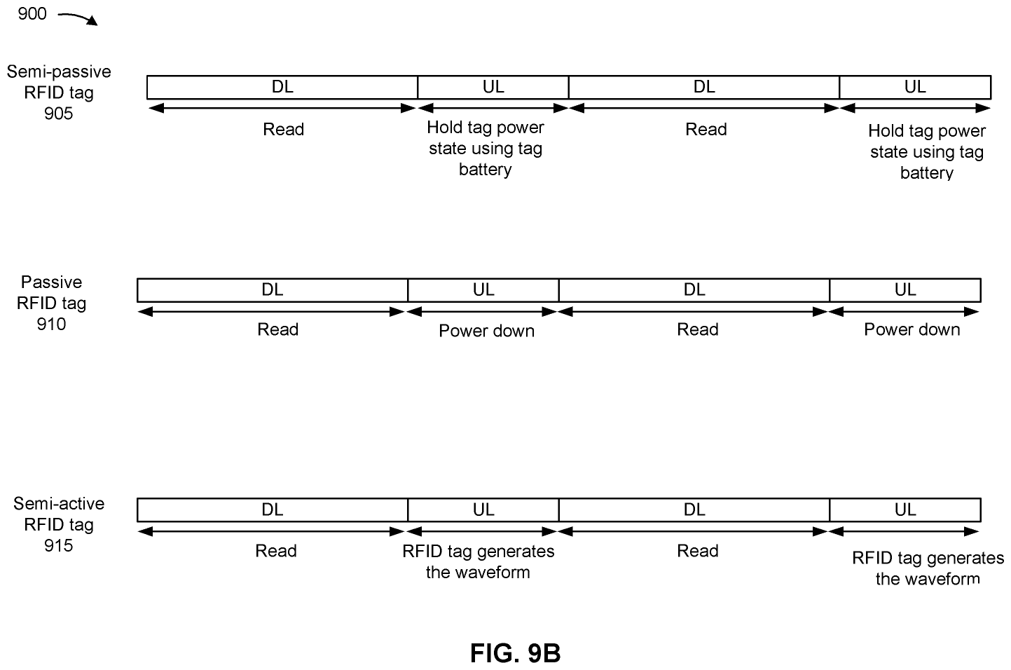

FIGS. 9A-9B are diagrams illustrating examples 900 of RFID tag powering, in accordance with the present disclosure. In a first example (example 1), a sub-band full-duplex (SBFD) slot for continuous uplink may enable an RFID tag (e.g., the RFID tag 615) to receive uplink communications for the duration (or a portion of the duration) of the slot. Similarly, an SBFD slot for continuous downlink may enable the RFID to receive downlink communications for the duration of the slot. This may enable the RFID tag to continuously receive CW signals, and therefore, the RFID tag may stay in the powered-up state. In a second example (example 2), a semi-passive RFID tag may include a battery, such as an energy harvesting rechargeable battery, and a capacitor. The battery and the capacitor may enable the RFID tag to stay in the powered-up state. In a third example (example 3), the network node 110 and/or the UE 120 may be configured to provide constant power to the RFID tag. This constant power may enable the RFID tag to stay in the powered-up state. In a fourth example (example 4), the RFID tag may be powered-up prior to receiving data (e.g., prior to receiving a command). For example, the RFID tag may receive a CW signal a certain time period before receiving the data. The CW signal may enable the RFID tag to enter the powered-up state before the data is transmitted to the RFID (or before the data is received by the RFID).

FIG. 9B shows example downlink (DL) and uplink (UL) communications for a semi-passive RFID tag 905, a passive RFID tag 910, and a semi-active RFID tag 915. The semi-passive RFID tag 905 may be powered-up using a battery and a capacitor, as described above in example 2 of FIG. 9A. For example, the semi-passive RFID tag 905 may perform a read operation during one or more downlink slots, and may hold (e.g., maintain) the powered-up state using the RFID tag battery during one or more uplink slots. As described herein, the passive RFID 910 tag may not include a battery. The passive RFID tag 910 may perform a read operation during one or more downlink slots, and may power down during one or more uplink slots.

As described herein, a passive RFID tag that does not include a battery may need to be powered-up each time that the RFID tag is to be used. For example, an RFID reader may need to transmit a CW signal that provides power to the RFID tag prior to the RFID tag receiving an input (e.g., data). However, the time period for powering up the RFID tag may be greater than 400 us. This may result in wasted time resources, particularly when the RFID tag is powered-up and powered-down frequently. In contrast, an active RFID tag or a semi-passive RFID tag may include a battery for maintaining the RFID tag in the powered-up state. This may reduce the time period for performing RFID communication since the RFID tag does not need to be powered-up each time the RFID tag is to be used. However, this may result in wasted power resources when the RFID tag is not being used.

Techniques and apparatuses are described herein for an RFID tag. In some aspects, the RFID tag may include a sensing component, an energy storage component, a power control command and beam control command processing unit, and at least one of a waveform generator, a power amplifier, or a low noise amplifier for providing a power signal to the RFID tag. In some aspects, the RFID tag may transmit, and a network node may receive, capability information that indicates a waveform generation capability of the RFID tag or a power control capability of the RFID tag. The network node may transmit, and the RFID tag may receive, an indication to perform a power control operation or a beam adjustment operation based at least in part on the capability information.

As described above, a passive RFID tag that does not include a battery may need to be powered-up each time that the RFID tag is to be used. This may result in wasted time resources, particularly when the RFID tag is powered-up and powered-down frequently. In contrast, an active RFID tag or a semi-passive RFID tag may include a battery for maintaining the RFID tag in the powered-up state. This may reduce the time period for performing RFID communications since the RFID tag does not need to be powered-up each time the RFID tag is to be used. However, this may result in wasted power resources when the RFID tag is not being used. Using the techniques and apparatuses described herein, the RFID tag may be powered-up using at least one of the waveform generator, the power amplifier, or the low noise amplifier. As shown in the example semi-active RFID tag 915, the RFID tag may perform a read operation during one or more downlink slots, and may generate a waveform using the power from the waveform generator, the power amplifier, or the low noise amplifier, during one or more uplink slots. This may reduce the amount of time that is needed for powering up the RFID tag, while reducing the power consumption of the RFID tag.

As indicated above, FIGS. 9A-9B are provided as examples. Other examples may differ from what is described with respect to FIGS. 9A-9B.

FIG. 10 shows an example of an RFID tag 1000, in accordance with the present disclosure. The RFID tag 1000 may be a semi-active RFID tag. The RFID tag 1000 may include a sensing component 1005. The sensing component 1005 may be configured to sense (e.g., detect and/or receive) an input, such as a CW input or a modulated command. The RFID tag 1000 may include an energy storage component 1010. The energy storage component 1010 may be configured to store energy, such as energy received from a CW signal or from any of the components described below (e.g., components 1020, 1025, and/or 1030) for providing power to the RFID tag 1000. The RFID tag 1000 may include a power control (PC) command and beam control (BC) command processing unit 1015. The PC command and BC command processing unit 1015 may be configured to adjust a power control property and/or a beam control property, such as a QCL property, a beamforming property, and/or a reference signal property associated with the RFID tag 1000. In some aspects, one or more of the sensing component 1005, the energy storage component 1010, or the PC command and BC command processing unit 1015 may be implemented in an IoT device (e.g., a passive IoT device) associated with the RFID tag 1000.

In some aspects, the RFID tag 1000 may include one or more of a waveform generator 1020, a power amplifier 1025, and a low noise amplifier 1030. For example, the RFID tag 1000 may include any one of the waveform generator 1020, the power amplifier 1025, or the low noise amplifier 1030. In another example, the RFID tag 1000 may include any two of the waveform generator 1020, the power amplifier 1025, and the low noise amplifier 1030. In another example, the RFID tag 1000 may include all three of the waveform generator 1020, the power amplifier 1025, and the low noise amplifier 1030.

In some aspects, the waveform generator 1020 may be configured to generate a waveform, such as a continuous wave signal or a modulated sine wave signal, having one or more frequency components. The waveform may be used to provide power to the RFID tag 1000. In some aspects, the power amplifier 1025 may be used to amplify a waveform, such as the waveform generated by the waveform generator 1020. In some aspects, the power amplifier 1025 may be configured to amplify and/or power scale a backscatter signal. For example, the power amplifier 1025 may multiply the backscatter signal by an amplification factor. The amplification factor may be an adjustable amplification factor. In some aspects, the power amplifier 1025 may be included in a signal amplification circuit. An output of the power amplifier 1025 may be used to provide power to the RFID tag 1000. In some aspects, the low noise amplifier 1030 may be configured to amplify a received signal, such as a CW signal or a command signal sent to the RFID tag 1000. The amplified signal may be used to provide power to the RFID tag 1000. In some aspects, the signal amplification circuit may be operated using a battery that is used to store energy. In some aspects, the signal amplification circuit may be operated using an RF signal (e.g., an incident signal). For example, the low noise amplifier signal may be used for reception and the power amplifier may be used for transmission of the waveform or backscatter signal.

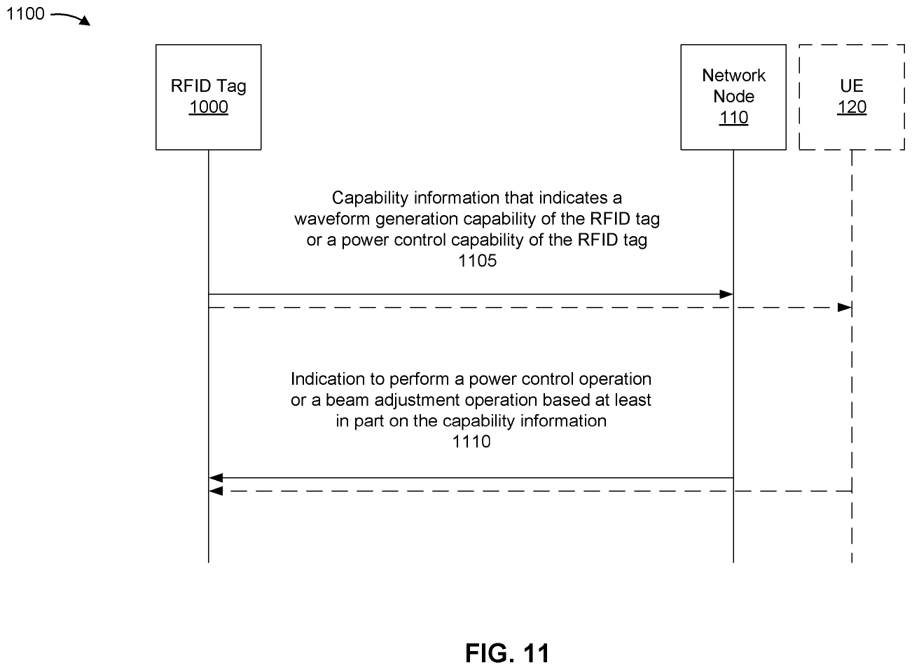

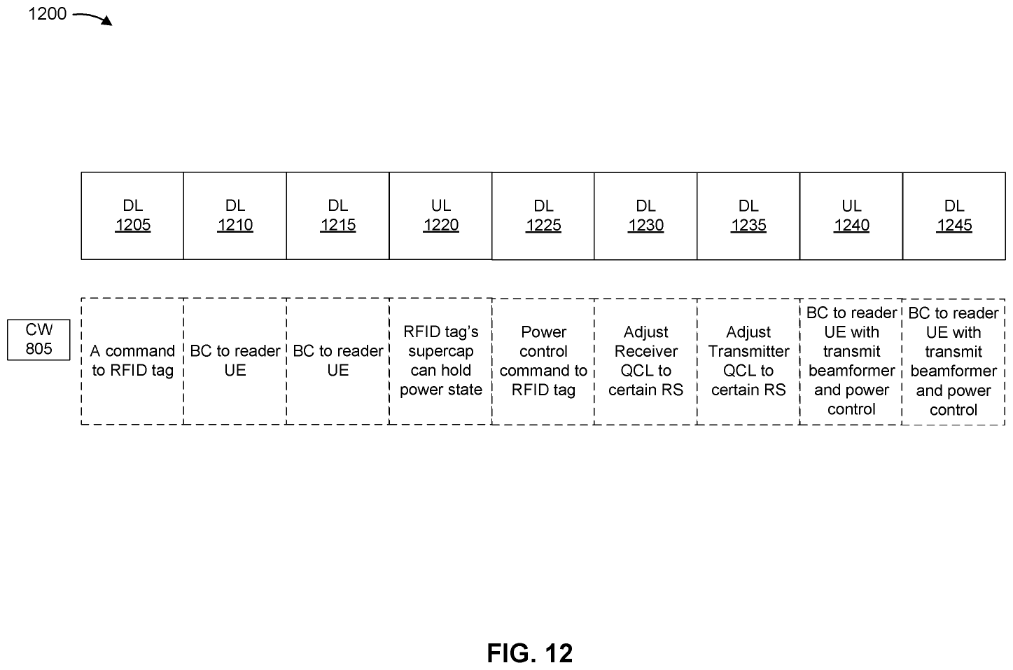

In some aspects, the RFID tag 1000 may be configured to transmit or receive information such as the signals described herein. Additionally, or alternatively, the RFID tag may be configured to perform one or more power control operations and/or one or more beam adjustment operations. Additional details regarding these features are described in connection with FIGS. 11 and 12.

As indicated above, FIG. 10 is provided as an example. Other examples may differ from what is described with respect to FIG. 10.

FIG. 11 is a diagram illustrating an example 1100 of RFID tag operations and communications, in accordance with the present disclosure. The RFID tag 1000 may communicate with the network node 110. In some aspects, the network node 110 may include some or all of the features of the aggregated base station or the disaggregated base station, such as some or all of the features of the CU 310, the RU 330, and/or the DU 340 described herein. In some aspects, the network node 110 may be the UE 120, or may include some or all of the features of the UE 120. For example, any of the features described herein as being performed by the network node 110 may be performed by the UE 120.

In some aspects, an RFID reader (such as the RFID reader 605) may be configured to read a signal received from the RFID tag 1000. In some aspects, an RFID source may be configured to transmit a command (and/or a power signal) to the RFID tag 1000. In some aspects, the network node 110 may be the RFID reader. In some aspects, the network node 110 may be the RFID source. In some aspects, the network node 110 may be, or may include, both the RFID reader and the RFID source.

As shown in connection with reference number 1105, the RFID tag 1000 may transmit, and the network node 110 may receive, capability information that indicates a waveform generation capability of the RFID tag and/or a power control capability of the RFID tag. In some aspects, transmitting the capability information may include transmitting an indication of whether the RFID tag 1000 includes a waveform generator (such as the waveform generator 1020), a power amplifier (such as the power amplifier 1025), a low noise amplifier (such as the low noise amplifier 1030), a PC command and BC command processing unit (such as the PC command and BC command processing unit 1015), and/or whether the RFID tag 1000 is equipped with multiple antennas. For example, the capability information may indicate the number of antennas associated with the RFID tag 1000. In some aspects, transmitting the capability information may include transmitting an indication of whether the RFID tag 1000 is capable of waveform generation, whether the RFID tag 1000 is capable of power amplification, whether the RFID tag 1000 is capable of low noise amplification, and/or whether the RFID tag 1000 is capable of PC command and BC command processing and adjustment.

In some aspects, transmitting the capability information may include transmitting an indication of a class associated with the RFID tag 1000. For example, the RFID tag 1000 may transmit a class identifier that indicates the class of the RFID tag 1000. In some aspects, the class identifier may indicate whether the RFID tag is an active RFID tag, a passive RFID tag, a semi-passive RFID tag, or a semi-active RFID tag. In some aspects, the class identifier may indicate whether the RFID tag 1000 includes a waveform generator, a power amplifier, a low noise amplifier, an ability to adjust a signal power, an ability to adjust a beam, whether the RFID tag is equipped with multiple antennas, or a combination thereof. For example a first class identifier may indicate that the RFID tag 1000 includes the waveform generator, a second class identifier may indicate that the RFID tag 1000 includes the power amplifier, a third class identifier may indicate that the RFID tag 1000 includes the low noise amplifier, a fourth class identifier may indicate that the RFID tag 1000 includes the waveform generator and the power amplifier, a fifth class identifier may indicate that the RFID tag 1000 includes the waveform generator and the low noise amplifier, a sixth class identifier may indicate that the RFID tag 1000 includes the power amplifier and the low noise amplifier, and a seventh class identifier may indicate that the RFID tag 1000 includes the waveform generator, the power amplifier, the low noise amplifier. Other combinations that include one or more other components of the RFID tag 1000 may also be indicated by the class identifier. In some aspects, the class identifier may indicate an ability of the RFID 1000 to change a receiver filter and/or a transmission filter, such as for processing QCL information or commands.

In some aspects, the RFID tag 1000 may transmit an indication of a maximum power level associated with the RFID tag 1000. In some aspects, the RFID tag 1000 may transmit a maximum power indicator (e.g., maxPowerPerClass) that indicates a maximum power level per class of the RFID tag 1000. For example, the maximum power indicator may indicate a first maximum power level based at least in part on the RFID tag 1000 being an active RFID tag, a second maximum power level based at least in part on the RFID tag 1000 being a passive RFID tag, a third maximum power level based at least in part on the RFID tag 1000 being a semi-passive RFID tag, or a fourth maximum power level based at least in part on the RFID tag 1000 being a semi-active RFID tag. In another example, the maximum power indicator may indicate a first maximum power level based at least in part on the RFID tag 1000 including the waveform generator, a second maximum power level based at least in part on the RFID tag 1000 including the power amplifier, or a third maximum power level based at least in part on the RFID tag 1000 including the low noise amplifier. Other power indicators may indicate a maximum power level associated with the RFID tag 1000 having other components and/or combinations of components (as described above).

As shown in connection with reference number 1110, the network node 110 may transmit, and the RFID tag 1000 may receive, an indication to perform a power control operation or a beam adjustment operation. The network node 110 may transmit the indication to perform the power control operation or the beam control operation based at least in part on the capability information received from the RFID tag 1000. For example, the network node 110 may determine the power control operation or the beam control operation, and may transmit the indication of the power control operation or the beam control operation, based at least in part on receiving an explicit indication of the capability information and/or based at least in part on receiving an indication of the class identifier associated with the RFID tag 1000.

In some aspects, the indication may indicate for the RFID tag 1000 to perform a power control using a certain power control level. The certain power control level may be included in the indication, or may otherwise be stored in the RFID tag 1000 or received by the RFID tag 1000. The indication to perform the power control using the certain power control level may be an indication to perform power control for or more backscatter slots (e.g., to adjust the power amplifier gain) or for one or more slots that are to be used by the RFID tag 1000 to generate a waveform. In some aspects, the indication may indicate for the RFID tag 1000 to adjust a transmit beamformer or a transmit filter for a QCL (e.g., QCL-D) with a reference signal. The reference signal may be an SRS, a CSI-RS, a time-domain reference signal that is particular to the RFID tag 1000, and/or a previous command signal or a backscatter signal. In some aspects, the indication may indicate for the RFID tag 1000 to adjust a receiver QCL based at least in part on a previous reference signal that was sent in the same (e.g., current) communication session between the network node 110 and the RFID tag 1000. The previous reference signal may be the previous command signal or the backscatter signal from the current communication session. In some aspects, the network node 110 (the RFID source and/or the RFID reader) may transmit an indication for the RFID tag 1000 to adjust one or more parameters of the low noise amplifier. For example, the network node 110 may transmit an indication for the RFID tag to adjust an automatic gain control (AGC) parameter and/or a scaling parameter for the low noise amplifier.

In some aspects, the power control or beam adjustment may be applied to slots where there is no CW. For example, the power control or beam adjustment may be applied in uplink slots when the network node 110 is the RFID source. In some aspects, the power control or beam adjustment may be applied to uplink slots and/or downlink slots when the network node 110 is the RFID reader. For example, the RFID reader may need a higher received power to be able to decode the backscatter signal (e.g., for improved reliability and range). In one example, when the components of the RFID tag 1000 are active during a downlink slot, the power amplifier 1025 may be active to receive the backscatter, and may be configured to amplify the backscatter. In this case, an output signal may have the format A*x_backscatter, where A is the gain from the power amplifier 1025 and x_backscatter is the backscatter signal, and the power of the output signal may be A². In another example, when the components of the RFID tag 1000 are active during a downlink slot, the RFID tag 1000 may generate a signal that is a replica of the backscatter signal using the waveform generator 1020. In this case, the output from the RFID tag 1000 may have two parts: x_backscatter+x_generated, where x_generated=B*x_backscatter, and where B is the gain from the power amplifier.

In some aspects, the network node 110 (acting as the RFID reader or the RFID source) may be configured to assist the RFID tag 1000 in adjusting the power control. For example, the network node 110 may transmit, and the RFID tag 1000 may receive, an absolute power control command that indicates a power level to be used for the power control. In another example, the network node 110 may transmit, and the RFID tag 1000 may receive, a delta power control command (e.g., an offset) during the communication session. In some cases, the RFID tag 1000 may not be able to store power control commands (or may not be able to store more than a number of power control commands) due to memory limits at the RFID tag 1000. In some aspects, the network node 110 (acting as the RFID reader) may send a power control command to another network node 110 (acting as the RFID source) or the UE 120 (acting as the RFID source). The network node 110 (acting as the RFID source) or the UE 120 (acting as the RFID source) may transmit (e.g., relay) the power control command to the RFID tag 1000 for adjusting the power control, the QCL, or a combination thereof.

As described above, a passive RFID tag that does not include a battery may need to be powered-up each time that the RFID tag is to be used. This may result in wasted time resources, particularly when the RFID tag is powered-up and powered-down frequently. In contrast, an active RFID tag or a semi-passive RFID tag may include a battery for maintaining the RFID tag in the powered-up state. This may reduce the time period for performing RFID communications since the RFID tag does not need to be powered-up each time the RFID tag is to be used. However, this may result in wasted power resources when the RFID tag is not being used. Using the techniques and apparatuses described herein, the RFID tag may be powered-up using at least one of the waveform generator, the power amplifier, or the low noise amplifier. This may reduce the amount of time that is needed for powering up the RFID tag, while reducing the power consumption of the RFID tag.

As indicated above, FIG. 11 is provided as an example. Other examples may differ from what is described with respect to FIG. 11.

FIG. 12 is a diagram illustrating an example 1200 of a communication session between an RFID tag and a network node, in accordance with the present disclosure. In some aspects, the network node 110 may transmit, and the RFID tag 1000 may receive, a CW signal (such as the CW 805). In downlink slot 1205, the network node 110 may transmit a command to the RFID tag 1000. In downlink slots 1210 and 1215, the network node 110 may transmit beam control indications to an RFID reader UE (or an RFID reader network node). In uplink slot 1220, the RFID tag 1000 may transmit an indication of a super-capacitor that can hold a power state for the RFID tag 1000. In downlink slot 1225, the network node 110 may transmit a power control command to the RFID tag 1000. In downlink slot 1230, the network node 110 may adjust a receiver QCL to a certain reference signal, such as the SRS or the CSI-RS described herein. In downlink slot 1235, the network node 110 may adjust a transmitter QCL to a certain reference signal, such as the SRS or the CSI-RS described herein. In uplink slot 1240, the RFID tag 1000 may transmit a beam control to the RFID reader (e.g., the network node 110) with a transmit beamformer and power control indication. In downlink slot 1245, the network node 110 may transmit a beam control to the RFID reader (e.g., the UE or another network node) with a transmit beamformer and power control indication.

As indicated above, FIG. 12 is provided as an example. Other examples may differ from what is described with respect to FIG. 12.

FIG. 13 is a diagram illustrating an example process 1300 performed, for example, by a UE (e.g., an RFID tag) RFID, in accordance with the present disclosure. Example process 1300 is an example where the UE 120 (e.g., the RFID tag 1000) performs operations associated with radio frequency identification tag operation and communication.

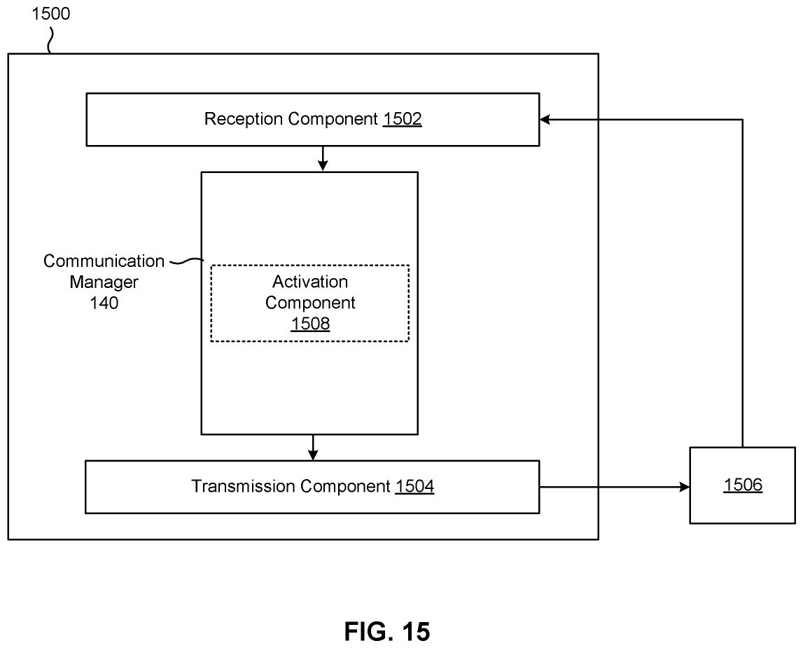

As shown in FIG. 13, in some aspects, process 1300 may include transmitting capability information that indicates a waveform generation capability of the RFID tag or a power control capability of the RFID tag (block 1310). For example, the UE (e.g., using communication manager 140 and/or transmission component 1504, depicted in FIG. 15) may transmit capability information that indicates a waveform generation capability of the RFID tag or a power control capability of the RFID tag, as described above.

As further shown in FIG. 13, in some aspects, process 1300 may include receiving, from a network node, an indication to perform a power control operation or a beam adjustment operation based at least in part on the capability information (block 1320). For example, the UE (e.g., using communication manager 140 and/or reception component 1502, depicted in FIG. 15) may receive, from a network node, an indication to perform a power control operation or a beam adjustment operation based at least in part on the capability information, as described above.

Process 1300 may include additional aspects, such as any single aspect or any combination of aspects described below and/or in connection with one or more other processes described elsewhere herein.

In a first aspect, transmitting the capability information comprises transmitting an indication of whether the RFID tag comprises a waveform generator, a power amplifier, a low noise amplifier, a power control and beam control processing unit, or whether the RFID tag is equipped with multiple antennas.

In a second aspect, alone or in combination with the first aspect, transmitting the capability information comprises transmitting a class identifier associated with the RFID tag.

In a third aspect, alone or in combination with one or more of the first and second aspects, the class identifier is associated with a plurality of class identifiers that respectively indicate whether the RFID tag is an active RFID tag, a passive RFID tag, a semi-passive RFID tag, or a semi-active RFID tag.

In a fourth aspect, alone or in combination with one or more of the first through third aspects, the class identifier is associated with a plurality of class identifiers that respectively indicate whether the RFID tag includes a waveform generator, a power amplifier, a low noise amplifier, an ability to adjust a signal power, an ability to adjust a beam, whether the RFID tag is equipped with multiple antennas, or a combination thereof.

In a fifth aspect, alone or in combination with one or more of the first through fourth aspects, the indication to perform the power control operation is an indication to perform power control for one or more backscatter slots or for one or more slots to be used by the RFID tag for generating a responsive waveform.

In a sixth aspect, alone or in combination with one or more of the first through fifth aspects, the indication to perform the beam adjustment operation is an indication to adjust a beamformer or a transmit filter based at least in part on quasi-co-location information associated with a reference signal.

In a seventh aspect, alone or in combination with one or more of the first through sixth aspects, the indication to perform the beam adjustment operation is received during a communication session and includes an indication to adjust a receiver quasi-co-location based at least in part on a reference signal that was sent during the communication session.

In an eighth aspect, alone or in combination with one or more of the first through seventh aspects, the indication to perform the power control operation indicates to perform the power control operation in one or more slots that do not include a continuous waveform.

In a ninth aspect, alone or in combination with one or more of the first through eighth aspects, the indication to perform the power control operation indicates to perform the power control operation in an uplink slot and a downlink slot.

In a tenth aspect, alone or in combination with one or more of the first through ninth aspects, process 1300 includes activating an amplification circuit for amplifying a backscatter signal.

In an eleventh aspect, alone or in combination with one or more of the first through tenth aspects, process 1300 includes activating a waveform generator for generating a waveform that is based at least in part on a backscatter signal.

In a twelfth aspect, alone or in combination with one or more of the first through eleventh aspects, process 1300 includes receiving an indication of an adjusted power control to be used by the RFID.

In a thirteenth aspect, alone or in combination with one or more of the first through twelfth aspects, the indication of the adjusted power control includes an absolute power value or a delta power value.

Although FIG. 13 shows example blocks of process 1300, in some aspects, process 1300 may include additional blocks, fewer blocks, different blocks, or differently arranged blocks than those depicted in FIG. 13. Additionally, or alternatively, two or more of the blocks of process 1300 may be performed in parallel.

FIG. 14 is a diagram illustrating an example process 1400 performed, for example, by a network node, in accordance with the present disclosure. Example process 1400 is an example where the network node (e.g., network node 110) performs operations associated with radio frequency identification tag operation and communication.

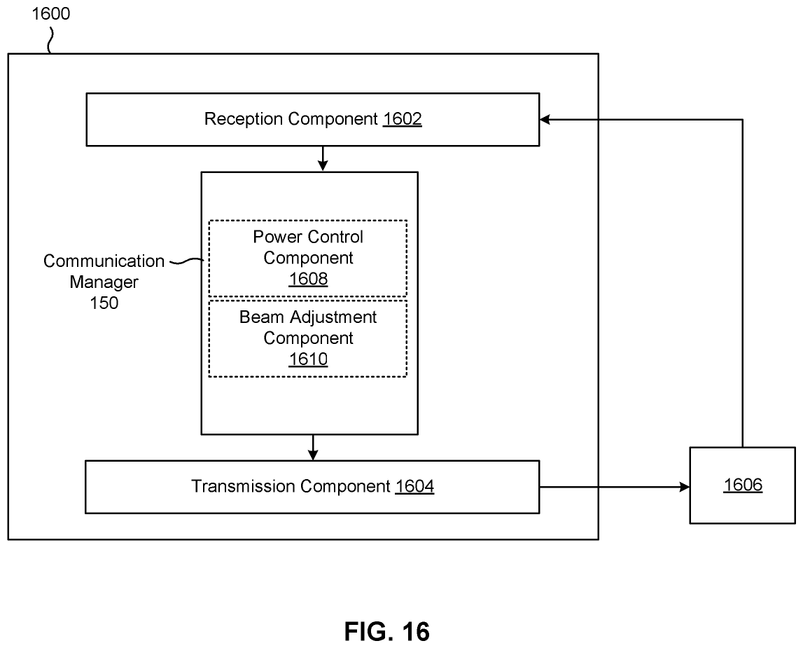

As shown in FIG. 14, in some aspects, process 1400 may include receiving, from a RFID tag, capability information that indicates a waveform generation capability of the RFID tag or a power control capability of the RFID tag (block 1410). For example, the network node (e.g., using communication manager 150 and/or reception component 1602, depicted in FIG. 16) may receive, from a RFID tag, capability information that indicates a waveform generation capability of the RFID tag or a power control capability of the RFID tag, as described above.

As further shown in FIG. 14, in some aspects, process 1400 may include transmitting, to the RFID tag, an indication to perform a power control operation or a beam adjustment operation based at least in part on the capability information (block 1420). For example, the network node (e.g., using communication manager 150 and/or transmission component 1604, depicted in FIG. 16) may transmit, to the RFID tag, an indication to perform a power control operation or a beam adjustment operation based at least in part on the capability information, as described above.

Process 1400 may include additional aspects, such as any single aspect or any combination of aspects described below and/or in connection with one or more other processes described elsewhere herein.

In a first aspect, receiving the capability information comprises receiving an indication of whether the RFID tag comprises a waveform generator, a power amplifier, a low noise amplifier, a power control and beam control processing unit, or whether the RFID tag is equipped with multiple antennas.

In a second aspect, alone or in combination with the first aspect, receiving the capability information comprises receiving a class identifier associated with the RFID tag.

In a third aspect, alone or in combination with one or more of the first and second aspects, the class identifier is associated with a plurality of class identifiers that respectively indicate whether the RFID tag is an active RFID tag, a passive RFID tag, a semi-passive RFID tag, or a semi-active RFID tag.

In a fourth aspect, alone or in combination with one or more of the first through third aspects, the class identifier is associated with a plurality of class identifiers that respectively indicate whether the RFID tag includes a waveform generator, a power amplifier, a low noise amplifier, an ability to adjust a signal power, an ability to adjust a beam, whether the RFID tag is equipped with multiple antennas, or a combination thereof.

In a fifth aspect, alone or in combination with one or more of the first through fourth aspects, the indication to perform the power control operation is an indication to perform power control for one or more backscatter slots or for one or more slots to be used by the RFID tag for generating a responsive waveform.

In a sixth aspect, alone or in combination with one or more of the first through fifth aspects, the indication to perform the beam adjustment operation is an indication to adjust a beamformer or a transmit filter based at least in part on quasi-co-location information associated with a reference signal.

In a seventh aspect, alone or in combination with one or more of the first through sixth aspects, the indication to perform the beam adjustment operation is transmitted during a communication session and includes an indication to adjust a receiver quasi-co-location based at least in part on a reference signal that was received during the communication session.

In an eighth aspect, alone or in combination with one or more of the first through seventh aspects, the indication to perform the power control operation indicates to perform the power control operation in one or more slots that do not include a continuous waveform.

In a ninth aspect, alone or in combination with one or more of the first through eighth aspects, the indication to perform the power control operation indicates to perform the power control operation in an uplink slot and a downlink slot.

In a tenth aspect, alone or in combination with one or more of the first through ninth aspects, process 1400 includes transmitting an indication of an adjusted power control to be used by the RFID.

In an eleventh aspect, alone or in combination with one or more of the first through tenth aspects, transmitting the indication to perform the power control operation or the beam adjustment operation comprises receiving, from another network node, a request to relay the indication to perform the power control operation or the beam adjustment operation to the RFID tag, and relaying, to the RFID tag, the indication to perform the power control operation or the beam adjustment operation.

In a twelfth aspect, alone or in combination with one or more of the first through eleventh aspects, transmitting the indication to perform the power control operation or the beam adjustment operation comprises transmitting, to another network node, a request to relay the indication to perform the power control operation or the beam adjustment operation to the RFID tag.

Although FIG. 14 shows example blocks of process 1400, in some aspects, process 1400 may include additional blocks, fewer blocks, different blocks, or differently arranged blocks than those depicted in FIG. 14. Additionally, or alternatively, two or more of the blocks of process 1400 may be performed in parallel.

FIG. 15 is a diagram of an example apparatus 1500 for wireless communication, in accordance with the present disclosure. The apparatus 1500 may be a UE, or a UE may include the apparatus 1500. In some aspects, the apparatus 1500 includes a reception component 1502 and a transmission component 1504, which may be in communication with one another (for example, via one or more buses and/or one or more other components). As shown, the apparatus 1500 may communicate with another apparatus 1506 (such as a UE, a base station, or another wireless communication device) using the reception component 1502 and the transmission component 1504. As further shown, the apparatus 1500 may include the communication manager 140. The communication manager 140 may include an activation component 1508, among other examples.

In some aspects, the apparatus 1500 may be configured to perform one or more operations described herein in connection with FIGS. 10-12. Additionally, or alternatively, the apparatus 1500 may be configured to perform one or more processes described herein, such as process 1300 of FIG. 13. In some aspects, the apparatus 1500 and/or one or more components shown in FIG. 15 may include one or more components of the UE described in connection with FIG. 2. Additionally, or alternatively, one or more components shown in FIG. 15 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1502 may receive communications, such as reference signals, control information, data communications, or a combination thereof, from the apparatus 1506. The reception component 1502 may provide received communications to one or more other components of the apparatus 1500. In some aspects, the reception component 1502 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1500. In some aspects, the reception component 1502 may include one or more antennas, a modem, a demodulator, a MIMO detector, a receive processor, a controller/processor, a memory, or a combination thereof, of the UE described in connection with FIG. 2.

The transmission component 1504 may transmit communications, such as reference signals, control information, data communications, or a combination thereof, to the apparatus 1506. In some aspects, one or more other components of the apparatus 1500 may generate communications and may provide the generated communications to the transmission component 1504 for transmission to the apparatus 1506. In some aspects, the transmission component 1504 may perform signal processing on the generated communications (such as filtering, amplification, modulation, digital-to-analog conversion, multiplexing, interleaving, mapping, or encoding, among other examples), and may transmit the processed signals to the apparatus 1506. In some aspects, the transmission component 1504 may include one or more antennas, a modem, a modulator, a transmit MIMO processor, a transmit processor, a controller/processor, a memory, or a combination thereof, of the UE described in connection with FIG. 2. In some aspects, the transmission component 1504 may be co-located with the reception component 1502 in a transceiver.

The transmission component 1504 may transmit capability information that indicates a waveform generation capability of the RFID tag or a power control capability of the RFID tag. The reception component 1502 may receive, from a network node, an indication to perform a power control operation or a beam adjustment operation based at least in part on the capability information.

The activation component 1508 may activate an amplification circuit for amplifying a backscatter signal. The activation component 1508 may activate a waveform generator for generating a waveform that is based at least in part on a backscatter signal. The reception component 1502 may receive an indication of an adjusted power control to be used by the RFID.

The number and arrangement of components shown in FIG. 15 are provided as an example. In practice, there may be additional components, fewer components, different components, or differently arranged components than those shown in FIG. 15. Furthermore, two or more components shown in FIG. 15 may be implemented within a single component, or a single component shown in FIG. 15 may be implemented as multiple, distributed components. Additionally, or alternatively, a set of (one or more) components shown in FIG. 15 may perform one or more functions described as being performed by another set of components shown in FIG. 15.

FIG. 16 is a diagram of an example apparatus 1600 for wireless communication, in accordance with the present disclosure. The apparatus 1600 may be a network node, or a network node may include the apparatus 1600. In some aspects, the apparatus 1600 includes a reception component 1602 and a transmission component 1604, which may be in communication with one another (for example, via one or more buses and/or one or more other components). As shown, the apparatus 1600 may communicate with another apparatus 1606 (such as a UE, a base station, or another wireless communication device) using the reception component 1602 and the transmission component 1604. As further shown, the apparatus 1600 may include the communication manager 150. The communication manager 150 may include one or more of a power control component 1608 or a beam adjustment component 1610, among other examples.

In some aspects, the apparatus 1600 may be configured to perform one or more operations described herein in connection with FIGS. 10-12. Additionally, or alternatively, the apparatus 1600 may be configured to perform one or more processes described herein, such as process 1400 of FIG. 14. In some aspects, the apparatus 1600 and/or one or more components shown in FIG. 16 may include one or more components of the network node described in connection with FIG. 2. Additionally, or alternatively, one or more components shown in FIG. 16 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1602 may receive communications, such as reference signals, control information, data communications, or a combination thereof, from the apparatus 1606. The reception component 1602 may provide received communications to one or more other components of the apparatus 1600. In some aspects, the reception component 1602 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1600. In some aspects, the reception component 1602 may include one or more antennas, a modem, a demodulator, a MIMO detector, a receive processor, a controller/processor, a memory, or a combination thereof, of the network node described in connection with FIG. 2.

The transmission component 1604 may transmit communications, such as reference signals, control information, data communications, or a combination thereof, to the apparatus 1606. In some aspects, one or more other components of the apparatus 1600 may generate communications and may provide the generated communications to the transmission component 1604 for transmission to the apparatus 1606. In some aspects, the transmission component 1604 may perform signal processing on the generated communications (such as filtering, amplification, modulation, digital-to-analog conversion, multiplexing, interleaving, mapping, or encoding, among other examples), and may transmit the processed signals to the apparatus 1606. In some aspects, the transmission component 1604 may include one or more antennas, a modem, a modulator, a transmit MIMO processor, a transmit processor, a controller/processor, a memory, or a combination thereof, of the network node described in connection with FIG. 2. In some aspects, the transmission component 1604 may be co-located with the reception component 1602 in a transceiver.

The reception component 1602 may receive, from a RFID tag, capability information that indicates a waveform generation capability of the RFID tag or a power control capability of the RFID tag. The transmission component 1604, the power control component 1608, and/or the beam adjustment component 1610 may transmit, to the RFID tag, an indication to perform a power control operation or a beam adjustment operation based at least in part on the capability information. The transmission component 1604 may transmit an indication of an adjusted power control to be used by the RFID.

The number and arrangement of components shown in FIG. 16 are provided as an example. In practice, there may be additional components, fewer components, different components, or differently arranged components than those shown in FIG. 16. Furthermore, two or more components shown in FIG. 16 may be implemented within a single component, or a single component shown in FIG. 16 may be implemented as multiple, distributed components. Additionally, or alternatively, a set of (one or more) components shown in FIG. 16 may perform one or more functions described as being performed by another set of components shown in FIG. 16.

The following provides an overview of some Aspects of the present disclosure:
Aspect 1: A radio frequency identification (RFID) tag comprising: a sensing component; an energy storage component; a power control command and beam control command processing unit; and at least one of a waveform generator, a power amplifier, or a low noise amplifier for providing a power signal to the RFID tag.
Aspect 2: The RFID tag of Aspect 1, wherein the RFID tag includes the waveform generator, and wherein the waveform generator is configured to generate a continuous wave signal having one or more frequency configurations.
Aspect 3: The RFID tag of any of Aspects 1-2, wherein the RFID tag includes the power amplifier, and wherein the power amplifier is configured to amplify a continuous wave signal and a backscatter signal that are generated by the RFID tag.
Aspect 4: The RFID tag of Aspect 3, wherein the power amplifier is configured to amplify the backscatter signal based at least in part on multiplying the backscatter signal by an adjustable amplification factor.
Aspect 5: The RFID tag of any of Aspects 1-4, wherein the RFID tag includes the low noise amplifier, and wherein the low noise amplifier is configured to amplify a command signal that is received by the RFID tag.
Aspect 6: A method of wireless communication performed by a radio frequency identification (RFID) tag, comprising: transmitting capability information that indicates a waveform generation capability of the RFID tag or a power control capability of the RFID tag; and receiving, from a network node, an indication to perform a power control operation or a beam adjustment operation based at least in part on the capability information.
Aspect 7: The method of Aspect 6, wherein transmitting the capability information comprises transmitting an indication of whether the RFID tag comprises a waveform generator, a power amplifier, a low noise amplifier, a power control and beam control processing unit, or whether the RFID tag is equipped with multiple antennas.
Aspect 8: The method of any of Aspects 6-7, wherein transmitting the capability information comprises transmitting a class identifier associated with the RFID tag.
Aspect 9: The method of Aspect 8, wherein the class identifier is associated with a plurality of class identifiers that respectively indicate whether the RFID tag is an active RFID tag, a passive RFID tag, a semi-passive RFID tag, or a semi-active RFID tag.
Aspect 10: The method of Aspect 8, wherein the class identifier is associated with a plurality of class identifiers that respectively indicate whether the RFID tag includes a waveform generator, a power amplifier, a low noise amplifier, an ability to adjust a signal power, an ability to adjust a beam, whether the RFID tag is equipped with multiple antennas, or a combination thereof.
Aspect 11: The method of any of Aspects 6-10, wherein the indication to perform the power control operation is an indication to perform power control for one or more backscatter slots or for one or more slots to be used by the RFID tag for generating a responsive waveform.
Aspect 12: The method of any of Aspects 6-11, wherein the indication to perform the beam adjustment operation is an indication to adjust a beamformer or a transmit filter based at least in part on quasi-co-location information associated with a reference signal.
Aspect 13: The method of any of Aspects 6-12, wherein the indication to perform the beam adjustment operation is received during a communication session and includes an indication to adjust a receiver quasi-co-location based at least in part on a reference signal that was sent during the communication session.
Aspect 14: The method of any of Aspects 6-13, wherein the indication to perform the power control operation indicates to perform the power control operation in one or more slots that do not include a continuous waveform.
Aspect 15: The method of any of Aspects 6-14, wherein the indication to perform the power control operation indicates to perform the power control operation in an uplink slot and a downlink slot.
Aspect 16: The method of Aspect 15, further comprising activating an amplification circuit for amplifying a backscatter signal.
Aspect 17: The method of Aspect 15, further comprising activating a waveform generator for generating a waveform that is based at least in part on a backscatter signal.
Aspect 18: The method of any of Aspects 6-17, further comprising receiving an indication of an adjusted power control to be used by the RFID.
Aspect 19: The method of Aspect 18, wherein the indication of the adjusted power control includes an absolute power value or a delta power value.
Aspect 20: A method of wireless communication performed by a network node, comprising: receiving, from a radio frequency identification (RFID) tag, capability information that indicates a waveform generation capability of the RFID tag or a power control capability of the RFID tag; and transmitting, to the RFID tag, an indication to perform a power control operation or a beam adjustment operation based at least in part on the capability information.
Aspect 21: The method of Aspect 20, wherein receiving the capability information comprises receiving an indication of whether the RFID tag comprises a waveform generator, a power amplifier, a low noise amplifier, a power control and beam control processing unit, or whether the RFID tag is equipped with multiple antennas.
Aspect 22: The method of any of Aspects 20-21, wherein receiving the capability information comprises receiving a class identifier associated with the RFID tag.
Aspect 23: The method of Aspect 22, wherein the class identifier is associated with a plurality of class identifiers that respectively indicate whether the RFID tag is an active RFID tag, a passive RFID tag, a semi-passive RFID tag, or a semi-active RFID tag.
Aspect 24: The method of Aspect 22, wherein the class identifier is associated with a plurality of class identifiers that respectively indicate whether the RFID tag includes a waveform generator, a power amplifier, a low noise amplifier, an ability to adjust a signal power, an ability to adjust a beam, whether the RFID tag is equipped with multiple antennas, or a combination thereof.
Aspect 25: The method of any of Aspects 20-24, wherein the indication to perform the power control operation is an indication to perform power control for one or more backscatter slots or for one or more slots to be used by the RFID tag for generating a responsive waveform.
Aspect 26: The method of any of Aspects 20-25, wherein the indication to perform the beam adjustment operation is an indication to adjust a beamformer or a transmit filter based at least in part on quasi-co-location information associated with a reference signal.
Aspect 27: The method of any of Aspects 20-26, wherein the indication to perform the beam adjustment operation is transmitted during a communication session and includes an indication to adjust a receiver quasi-co-location based at least in part on a reference signal that was received during the communication session.
Aspect 28: The method of any of Aspects 20-27, wherein the indication to perform the power control operation indicates to perform the power control operation in one or more slots that do not include a continuous waveform.
Aspect 29: The method of any of Aspects 20-28, wherein the indication to perform the power control operation indicates to perform the power control operation in an uplink slot and a downlink slot.
Aspect 30: The method of any of Aspects 20-29, further comprising transmitting an indication of an adjusted power control to be used by the RFID.
Aspect 31: The method of any of Aspects 20-30, wherein transmitting the indication to perform the power control operation or the beam adjustment operation comprises: receiving, from another network node, a request to relay the indication to perform the power control operation or the beam adjustment operation to the RFID tag; and relaying, to the RFID tag, the indication to perform the power control operation or the beam adjustment operation.
Aspect 32: The method of any of Aspects 20-31, wherein transmitting the indication to perform the power control operation or the beam adjustment operation comprises: transmitting, to another network node, a request to relay the indication to perform the power control operation or the beam adjustment operation to the RFID tag.
Aspect 33: An apparatus for wireless communication at a device, comprising a processor; memory coupled with the processor, and instructions stored in the memory and executable by the processor to cause the apparatus to perform the method of one or more of Aspects 1-5.
Aspect 34: A device for wireless communication, comprising a memory and one or more processors coupled to the memory, the one or more processors configured to perform the method of one or more of Aspects 1-5.
Aspect 35: An apparatus for wireless communication, comprising at least one means for performing the method of one or more of Aspects 1-5.
Aspect 36: A non-transitory computer-readable medium storing code for wireless communication, the code comprising instructions executable by a processor to perform the method of one or more of Aspects 1-5.
Aspect 37: A non-transitory computer-readable medium storing a set of instructions for wireless communication, the set of instructions comprising one or more instructions that, when executed by one or more processors of a device, cause the device to perform the method of one or more of Aspects 1-5.
Aspect 38: An apparatus for wireless communication at a device, comprising a processor; memory coupled with the processor; and instructions stored in the memory and executable by the processor to cause the apparatus to perform the method of one or more of Aspects 6-19.
Aspect 39: A device for wireless communication, comprising a memory and one or more processors coupled to the memory, the one or more processors configured to perform the method of one or more of Aspects 6-19.
Aspect 40: An apparatus for wireless communication, comprising at least one means for performing the method of one or more of Aspects 6-19.
Aspect 41: A non-transitory computer-readable medium storing code for wireless communication, the code comprising instructions executable by a processor to perform the method of one or more of Aspects 6-19.
Aspect 42: A non-transitory computer-readable medium storing a set of instructions for wireless communication, the set of instructions comprising one or more instructions that, when executed by one or more processors of a device, cause the device to perform the method of one or more of Aspects 6-19.
Aspect 43: An apparatus for wireless communication at a device, comprising a processor; memory coupled with the processor, and instructions stored in the memory and executable by the processor to cause the apparatus to perform the method of one or more of Aspects 20-32.
Aspect 44: A device for wireless communication, comprising a memory and one or more processors coupled to the memory, the one or more processors configured to perform the method of one or more of Aspects 20-32.
Aspect 45: An apparatus for wireless communication, comprising at least one means for performing the method of one or more of Aspects 20-32.
Aspect 46: A non-transitory computer-readable medium storing code for wireless communication, the code comprising instructions executable by a processor to perform the method of one or more of Aspects 20-32.
Aspect 47: A non-transitory computer-readable medium storing a set of instructions for wireless communication, the set of instructions comprising one or more instructions that, when executed by one or more processors of a device, cause the device to perform the method of one or more of Aspects 20-32.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A radio frequency identification (RFID) tag comprising:
a sensing component;
an energy storage component;
a power control command and beam control command processing unit; and
at least one of a waveform generator, a power amplifier, or a low noise amplifier for providing a power signal to the RFID tag.

2. The RFID tag of claim 1, wherein the RFID tag includes the waveform generator, and wherein the waveform generator is configured to generate a continuous wave signal having one or more frequency configurations.

3. The RFID tag of claim 1, wherein the RFID tag includes the power amplifier, and wherein the power amplifier is configured to amplify a continuous wave signal and a backscatter signal that are generated by the RFID tag.

4. The RFID tag of claim 3, wherein the power amplifier is configured to amplify the backscatter signal based at least in part on multiplying the backscatter signal by an adjustable amplification factor.

5. The RFID tag of claim 1, wherein the RFID tag includes the low noise amplifier, and wherein the low noise amplifier is configured to amplify a command signal that is received by the RFID tag.

6. An apparatus for wireless communication at a radio frequency identification (RFID) tag, comprising:
a memory; and
one or more processors, coupled to the memory, configured to:
transmit capability information that indicates a waveform generation capability of the RFID tag or a power control capability of the RFID tag; and
receive, from a network node, an indication to perform a power control operation or a beam adjustment operation based at least in part on the capability information.

7. The apparatus of claim 6, wherein the one or more processors, to transmit the capability information, are configured to transmit an indication of whether the RFID tag comprises a waveform generator, a power amplifier, a low noise amplifier, a power control and beam control processing unit, or whether the RFID tag is equipped with multiple antennas.

8. The apparatus of claim 6, wherein the one or more processors, to transmit the capability information, are configured to transmit a class identifier associated with the RFID tag.

9. The apparatus of claim 8, wherein the class identifier is associated with a plurality of class identifiers that respectively indicate whether the RFID tag is an active RFID tag, a passive RFID tag, a semi-passive RFID tag, or a semi-active RFID tag.

10. The apparatus of claim 8, wherein the class identifier is associated with a plurality of class identifiers that respectively indicate whether the RFID tag includes a waveform generator, a power amplifier, a low noise amplifier, an ability to adjust a signal power, an ability to adjust a beam, whether the RFID tag is equipped with multiple antennas, or a combination thereof.

11. The apparatus of claim 6, wherein the indication to perform the power control operation is an indication to perform power control for one or more backscatter slots or for one or more slots to be used by the RFID tag for generating a responsive waveform.

12. The apparatus of claim 6, wherein the indication to perform the beam adjustment operation is an indication to adjust a beamformer or a transmit filter based at least in part on quasi-co-location information associated with a reference signal.

13. The apparatus of claim 6, wherein the indication to perform the beam adjustment operation is received during a communication session and includes an indication to adjust a receiver quasi-co-location based at least in part on a reference signal that was sent during the communication session.

14. The apparatus of claim 6, wherein the indication to perform the power control operation indicates to perform the power control operation in one or more slots that do not include a continuous waveform.

15. The apparatus of claim 6, wherein the indication to perform the power control operation indicates to perform the power control operation in an uplink slot and a downlink slot.

16. The apparatus of claim 15, wherein the one or more processors are further configured to activate an amplification circuit for amplifying a backscatter signal.

17. The apparatus of claim 15, wherein the one or more processors are further configured to activate a waveform generator for generating a waveform that is based at least in part on a backscatter signal.

18. The apparatus of claim 6, wherein the one or more processors are further configured to receive an indication of an adjusted power control to be used by the RFID.

19. An apparatus for wireless communication at a network node, comprising:
a memory; and
one or more processors, coupled to the memory, configured to:
receive, from a radio frequency identification (RFID) tag, capability information that indicates a waveform generation capability of the RFID tag or a power control capability of the RFID tag; and
transmit, to the RFID tag, an indication to perform a power control operation or a beam adjustment operation based at least in part on the capability information.

20. The apparatus of claim 19, wherein the one or more processors, to receive the capability information, are configured to receive an indication of whether the RFID tag comprises a waveform generator, a power amplifier, a low noise amplifier, a power control and beam control processing unit, or whether the RFID tag is equipped with multiple antennas.

21. The apparatus of claim 19, wherein the one or more processors, to receive the capability information, are configured to receive a class identifier associated with the RFID tag.

22. The apparatus of claim 21, wherein the class identifier is associated with a plurality of class identifiers that respectively indicate whether the RFID tag is an active RFID tag, a passive RFID tag, a semi-passive RFID tag, or a semi-active RFID tag.

23. The apparatus of claim 21, wherein the class identifier is associated with a plurality of class identifiers that respectively indicate whether the RFID tag includes a waveform generator, a power amplifier, a low noise amplifier, an ability to adjust a signal power, an ability to adjust a beam, whether the RFID tag is equipped with multiple antennas, or a combination thereof.

24. The apparatus of claim 19, wherein the indication to perform the power control operation is an indication to perform power control for one or more backscatter slots or for one or more slots to be used by the RFID tag for generating a responsive waveform.

25. The apparatus of claim 19, wherein the indication to perform the beam adjustment operation is an indication to adjust a beamformer or a transmit filter based at least in part on quasi-co-location information associated with a reference signal.

26. The apparatus of claim 19, wherein the indication to perform the beam adjustment operation is transmitted during a communication session and includes an indication to adjust a receiver quasi-co-location based at least in part on a reference signal that was received during the communication session.

27. (canceled)

28. The apparatus of claim 19, wherein the indication to perform the power control operation indicates to perform the power control operation in an uplink slot and a downlink slot.

29. The apparatus of claim 19, wherein the one or more processors, to transmit the indication to perform the power control operation or the beam adjustment operation, are configured to:
receive, from another network node, a request to relay the indication to perform the power control operation or the beam adjustment operation to the RFID tag; and
relay, to the RFID tag, the indication to perform the power control operation or the beam adjustment operation.

30. The apparatus of claim 19, wherein the one or more processors, to transmit the indication to perform the power control operation or the beam adjustment operation, are configured to:
transmit, to another network node, a request to relay the indication to perform the power control operation or the beam adjustment operation to the RFID tag.

31. A method of wireless communication performed by a radio frequency identification (RFID) tag, comprising:
transmitting capability information that indicates a waveform generation capability of the RFID tag or a power control capability of the RFID tag; and
receiving, from a network node, an indication to perform a power control operation or a beam adjustment operation based at least in part on the capability information.

32-35. (canceled)
